(19) United States
(12) Patent Application Publication
(10) Pub. No.: US 2002/0092186 A1
(43) Pub. Date: Jul. 18, 2002

(54) Gimballed lens mount and alignment assembly for a sensitive optical alignment

(76) Inventors: Bruce R. Napier, Torquay (GB); Steven Freer, Paignton (GB)

Correspondence Address: Christopher J. Cianciolo, Esq., Nortel Networks Limited, 600 Technology Park Drive, Billerica, MA, 01821-5501, US

(21) Appl. No.: 10/024,972

(22) Filed: Dec. 19, 2001

Related U.S. Application Data
(63) Continuation-in-part of application No. 09/859,999, filed on May 17, 2001.
(60) Provisional application No. 60/204,968, filed on May 17, 2000.

(51) Int. Cl. G01C 15/00

(52) U.S. Cl. 33/286

(57) ABSTRACT

Apparatus is disclosed for aligning optical components. The apparatus may for instance comprise a light source providing an emission, an optical element for receiving the emission from the light source, and at least one of the light source and the optical element being mounted to a gimbal mount. Adjustment of the light source and/or the optical element mounted to the gimbal mount adjusts the angle of incidence of the emission from the light source on the optical element. This adjustment in turn aligns the optical components, A method is disclosed for aligning optical components. The method comprises generating an emission from a light source, adjusting a gimbal mount on at least one of the light source and an optical element, wherein the angle of incidence of the emission from the light source is adjusted on the optical element, and fixing in place the position of the gimbal mount on the light source and/or the optical element.

### RELATED PATENT APPLICATIONS

This is a Continuation-in-Part patent application from patent application Ser. No. 09/859,999, filed May 5, 2001 by Chris Duska et al. for GIMBALED LENS MOUNT AND ALIGNMENT ASSEMBLY FOR A SENSITIVE OPTICAL ALIGNMENT, which patent application Ser. No. 09/859,999 itself claims benefit of pending prior U.S. Provisional Patent Application Serial No. 60/204,968, filed May 5, 2000 by Chris Duska et al. for GIMBALED LENS MOUNT AND ALIGNMENT ASSEMBLY FOR A SENSITIVE OPTICAL ALIGNMENT (Attorney's Docket No. CORE-65 PROV), which patent application is hereby incorporated herein by reference.

### FIELD OF THE INVENTION

This invention relates to optical alignment apparatus and methods in general, and more particularly to apparatus and methods for optical alignment using gimballed mounts. One preferred form of gimballed mount is a mount in which two integers provided with mating spherical surfaces are held against each other so as to afford the possibility of adjusting about three orthogonal axes the angular orientation of one of the integers with respect to the other.

### BACKGROUND TO THE INVENTION

Sometimes there is a need to precisely align optical components during construction of a system. For example it may be desired to use an etalon to generate an output profile corresponding to the ITU communication grid.

An etalon has a transmission profile characterized by a series of spaced peaks. The angle of incidence of an input beam affects the location of these peaks, the period of these peaks, and the profile of these peaks. Therefore, relative to the etalon, can generate an output profile corresponding to the ITU grid.

A preferred technique for adjusting the output profile of the etalon includes selecting the proper etalon, generating an incident light beam, observing the etalon output, adjusting the angle of incidence until the desired output profile (i.e., the ITU communication grid) is achieved, and then locking the angle of incidence.

It is to be clearly understood that the invention is not limited solely to the precise permanent alignment of etalons with respect to incident light form a second optical component such as a laser diode, but is applicable more generally to securing in permanent precise fixed spatial relationship not only these components, but also other combinations of a variety of miniature optical components including graded index lenses, miniature dielectric filters, waveplates, polarizers and the like. In such applications an important consideration is that the process of permanent fixing, for instance by laser beam welding or by the use of an adhesive such as an epoxy resin or solder, should not itself have the effect of disturbing the spatial relationship. Another consideration may be the need to ensure that the process of permanent fixing does not unevenly stress the miniature components in a manner and to an extent such as to introduce unacceptably large polarisation sensitivity, or to change significantly pre-existing (intentional) polarisation sensitivity.

### SUMMARY OF THE INVENTION

An object of the invention is to provide an apparatus for aligning optical components.

Another object of the invention is to provide an apparatus for aligning optical components and fixing their position relative to one another.

A further object of the invention is to provide a method for aligning optical components.

With the above and other objects in view, as will hereinafter appear, there is, according to a first aspect of the present invention, provided an apparatus for aligning optical components, the apparatus comprising: a light source providing an emission; an optical element for receiving the emission from the light source; and at least one of the light source and the optical element being mounted to a gimbal mount, wherein adjustment of the at least one of the light source and the optical element adjusts the angle of incidence of the emission from the light source on the optical element, whereby to align the optical components.

In accordance with a further feature of the invention, there is provided a means for positionally fixing the gimbal mount having an optical component mounted thereto.

In accordance with a second aspect of the invention, there is provided a method for aligning optical components, the method comprising: generating an emission from a light source; adjusting a gimbal mount on at least one of the light source and an optical element, wherein the angle of incidence of the emission from the light source is adjusted on the optical element; and fixing in place the position of the gimbal mount on the at least one of the light source and the optical element in place.

In accordance with a third aspect of the invention, there is provided an optical device having a first optical element permanently secured in fixed spaced relationship with and substantially optimally optically coupled with, a second optical element, wherein the first optical element is permanently secured to a substrate, the second optical element is permanently secured to a mount, and wherein the mount is permanently secured to the substrate by an adhesive layer between mating faces of complementary spherical curvature.

This use of adhesive secured spherical surfaces of complementary curvature avoids some of the problems of securing miniature optical components with adhesive in permanent precise spatial alignment. Such problems are liable to arise when the angular adjustment necessary to achieve the desired spatial relationship requires the adhesive to have the form of a wedge-shaped fillet between substantially planar surfaces. It has been found that the curing of such wedge-shaped fillets of adhesive is liable to disturb the alignment due to the setting up of significant asymmetric stresses, to introduce poor temperature tracking, and in certain circumstances to introduce polarization problems due to the stress field penetrating to an appreciable extent into the adhesive bonded miniature component itself.

In accordance with a fourth aspect of the invention, there is provided a method of permanently securing a first optical element in fixed spaced relationship with, and substantially optimally optically coupled with, a second optical element, which method includes the step of permanently securing the first optical element to a substrate, the step of permanently securing the second optical element to a mount, and wherein the step of permanently securing the second optical element to the mount is followed by the step of permanently securing the mount to the substrate with adhesive located between mating surfaces of complementary spherical curvature respectively forming parts of the mount and of the substrate.

The above and other features of the invention, including various novel details of construction and combinations of parts and method steps, will now be more particularly described with reference to the accompanying drawings and pointed out in the claims. It will be understood that the particular devices and method steps embodying the invention are shown by way of illustration only and not as limitation of the invention. The principles and features of this invention may be employed in various and numerous embodiments without departing from the scope of the invention.

### BRIEF DESCRIPTION OF THE DRAWINGS

These and other objects and features of the present invention will be more fully disclosed or rendered obvious by the following detailed description of the preferred embodiments of the invention, which is to be considered together with the accompanying drawings wherein like numbers refer to like parts, and further wherein:

FIG. 1 is a perspective view of one form of an apparatus for aligning optical components, illustrative of an embodiment of the invention;

FIG. 2 is a diagrammatic illustration of an apparatus for aligning optical components, showing the socket portion of a horizontal gimbal mount;

FIG. 3 is a diagrammatic illustration of an apparatus for aligning optical components, showing the socket portion of a vertical gimbal mount;

FIG. 4 is a diagrammatic illustration of an apparatus for aligning optical components, showing the counterbore portion of a horizontal gimbal mount;

FIG. 5 is a diagrammatic illustration of an apparatus for aligning optical components, showing the counterbore portion of a vertical gimbal mount;

FIG. 6 is a diagrammatic illustration of an apparatus for aligning optical components, showing the counterbore portion of a vertical gimbal mount;

FIG. 7 is a diagrammatic illustration of an apparatus for aligning optical components, showing a three-point contact of a gimbal mount,

FIG. 8 is a diagrammatic part-sectioned longitudinal elevational view of an alternative apparatus for aligning optical components,

FIG. 9 is a diagrammatic plan view of the alternative apparatus of FIG. 8.

### DETAILED DESCRIPTION OF THE PREFERRED EMBODIMENTS

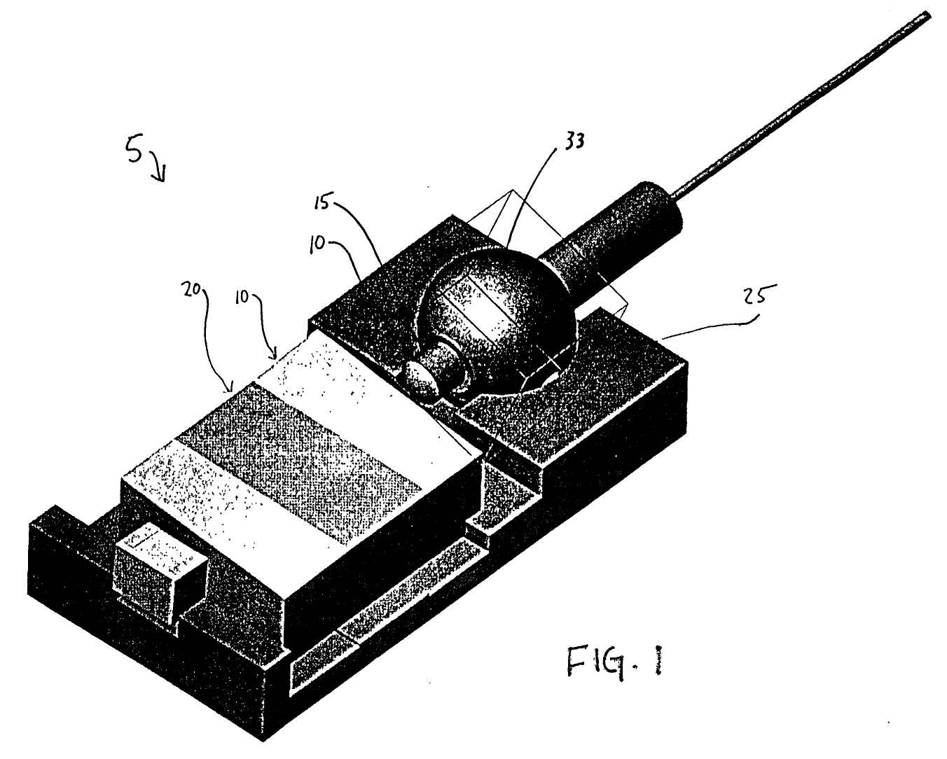

Referring to FIG. 1, apparatus 5 is shown for aligning two optical components 10. In a preferred embodiment of the invention, optical components 10 are generally described herein as a light source 15 and an etalon 20. Apparatus 5 includes light source 15 providing an emission (not shown), etalon 20 receiving the emission from light source 15, and a gimbal mount 25 supporting light source 15. Adjustment of light source 15 supported by gimbal mount 25 changes the angle of incidence of the emission (not shown) on etalon 20 from light source 15. This adjustment in turn aligns optical components 10. In addition, output from etalon 20 may be monitored, i.e., so as to achieve the desired output profile from etalon 20. Gimbal mount 25 is then fixed in position after achieving the desired output profile. This monitoring may include a feedback loop to establish the proper angle of incidence prior to locking gimbal mount 25, or gimbal mounts 25, into position.

In an alternative embodiment (not shown), etalon 20 is mounted to gimbal mount 25. Adjustment of etalon 20 supported by gimbal mount 25 changes the angle of incidence of the emission (not shown) from light source 15 on etalon 20. This adjustment in turn aligns optical components 10. In addition, output from etalon 5 may be monitored, i.e., so as to achieve the desired output profile from etalon 20. Gimbal mount 25 is then fixed in position after achieving the desired output profile from etalon 20. This monitoring may include a feedback loop to establish the proper angle of incidence prior to locking gimbal mount 25, or gimbal mounts 25, into position.

In another alternative embodiment (not shown), both light source 15 and etalon 20 are each mounted on separate gimbal mounts 25. Adjustment of either, or both, light source 15 supported by its own gimbal mount 25 or etalon 20 supported by its own gimbal mount 25 adjusts the angle of incidence of the emission (not shown) from light source 15 on etalon 20. This adjustment in turn aligns the optical components 10. In addition, output from etalon 5 may be monitored, i.e., so as to achieve the desired output profile from etalon 20. The two gimbal mounts 25 are then fixed in position after achieving the desired output profile. This monitoring may include a feedback loop to establish the proper angle of incidence prior to locking gimbal mounts 25 in position.

A method is disclosed for aligning optical components 10. The method comprises generating the emission from light source 15, adjusting light source 15 supported by its own gimbal mount 25 and/or optical element 20 supported by its own gimbal mount 25, wherein the angle of incidence of the emission from light source 15 is adjusted on optical element 20, and fixing in place the position of gimbal mount 25 with light source 15 and/or with optical element 20.

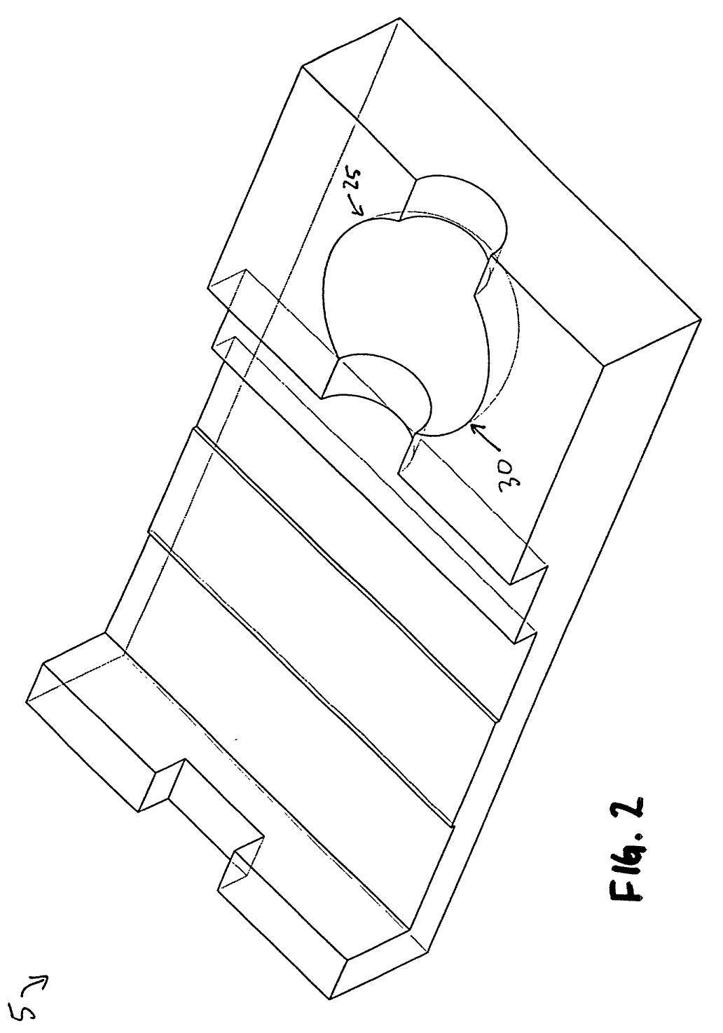

Referring to FIGS. 2-7, there are shown three basic types of gimbal mounts 25.

Looking at FIG. 2, apparatus 5 is shown having a socket 30 formed therein. Socket 30 and the curved element 33 (FIG. 1) together form gimbal mount 25. Socket 30 has a curved surface that corresponds to the outer surface of curved element 33 so as to make surface contact. In this embodiment of the invention, socket 30 is horizontally disposed for horizontal use of apparatus 5.

During use, once the angle of incidence is established, curved element 33 is fixed in position relative to socket 30. This fixation includes, but is not limited to, laser welding, soldering and epoxying curved element 33 at a fixed position relative to socket 30.

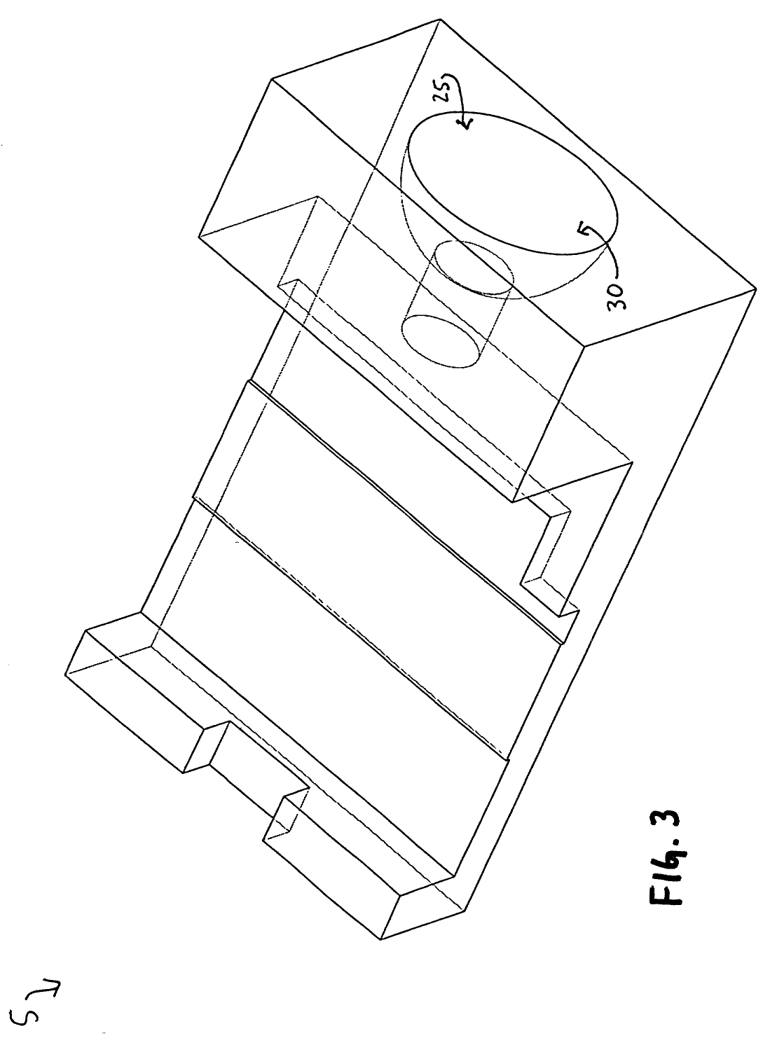

Looking at FIG. 3, apparatus 5 is shown having a socket 30 formed therein. Socket 30 and curved element 33 together from gimbal mount 25. Socket 30 has a curved surface that corresponds to the outer surface of curved element 33 so as to make surface contact. In this embodiment of the invention, socket 30 is vertically disposed for vertical use of apparatus 5.

During use, once the angle of incidence is established, curved element 33 is fixed in position relative to socket 30. This fixation includes, but is not limited to, laser welding, soldering and epoxying curved element 33 at a fixed position relative to socket 30.

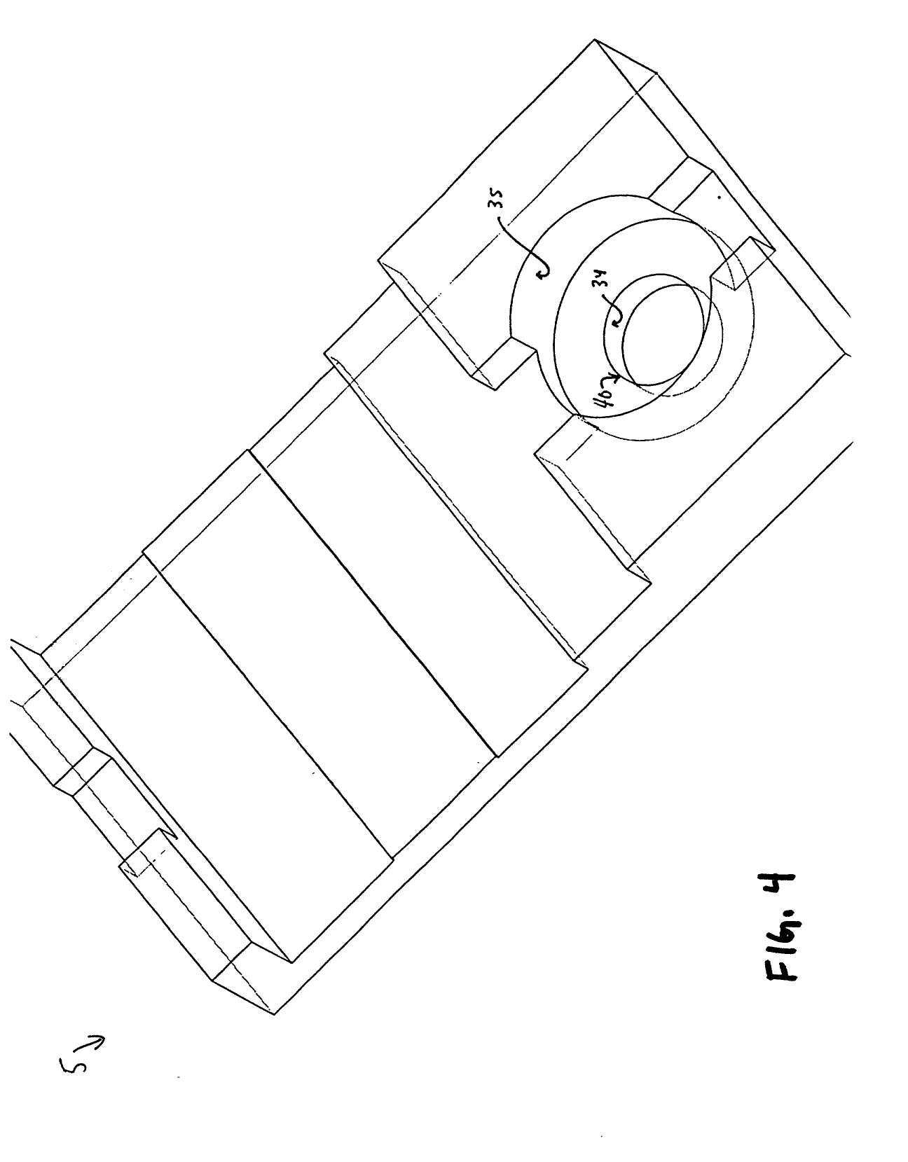

Looking at FIG. 4, apparatus 5 is shown having a bore 34 and counterbore 35 formed therein. Bore 34, counterbore 35 and curved element 33 together form gimbal mount 25. Bore 34 and counterbore 35 form a rim 40 that makes a line contact with curved element 33. In this embodiment of the invention, bore 34 and counterbore 35 are horizontally disposed for horizontal use of apparatus 5.

During use, once the angle of incidence is established, curved element 33 is fixed into position relative to counterbore 35. This fixation includes, but is not limited to, laser welding, soldering and epoxying curved element 33 at a fixed position relative to counterbore 35.

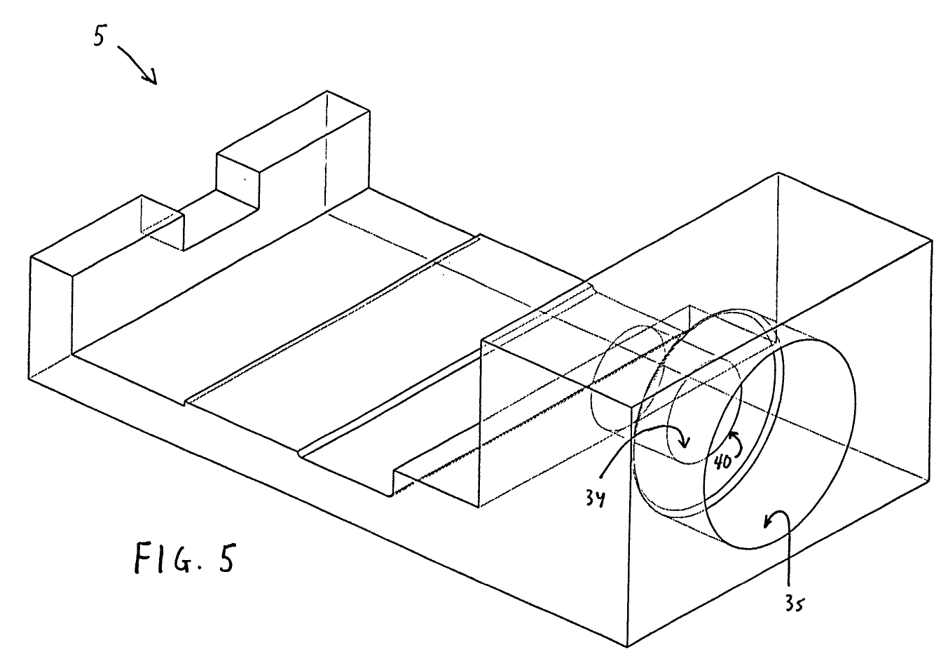

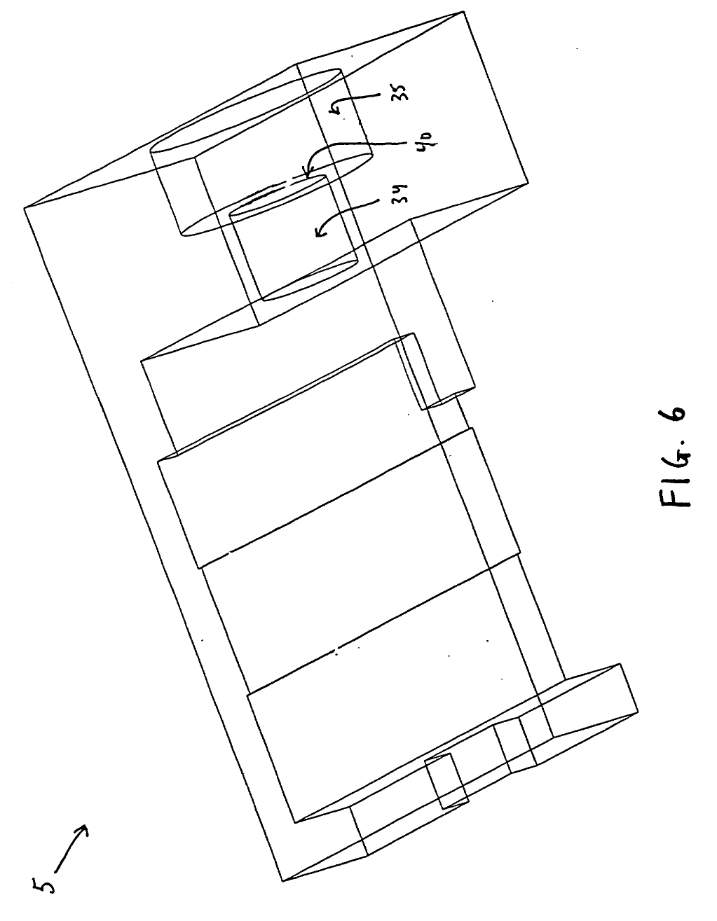

Looking at FIGS. 5 and 6, apparatus 5 is shown having a bore 34 and counterbore 35 formed therein. Bore 34, counterbore 35 and curved element 33 together form gimbal mount 25. Bore 34 and counterbore 35 form rim 40 that makes a line contact with curved element 33. In this embodiment of the invention, bore 34 and counterbore 35 are vertically disposed for vertical use of apparatus 5.

During use, once the angle of incidence is established, curved element 33 is fixed in position relative to counterbore 35. This fixation includes, but is not limited to, laser welding, soldering and epoxying curved element 33 at a fixed position relative to counterbore 35.

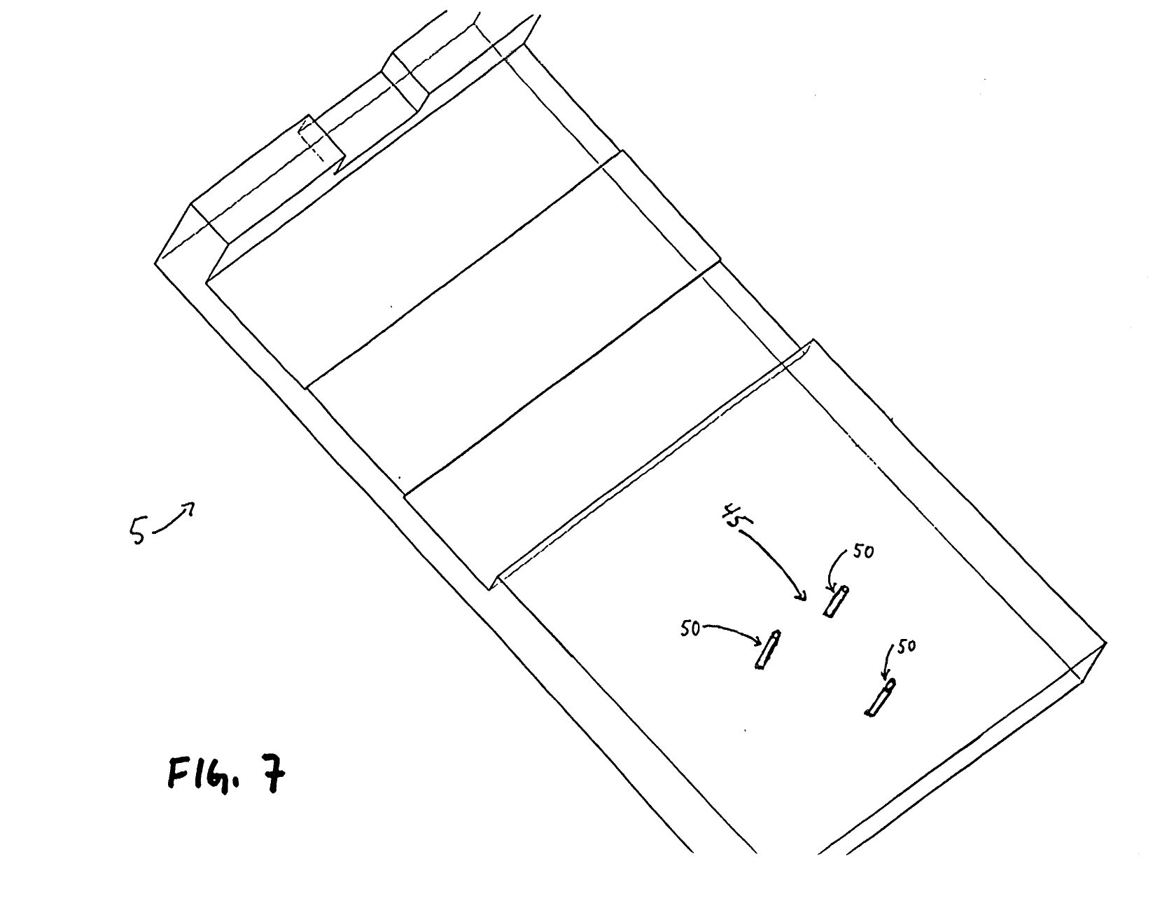

Looking at FIG. 7, apparatus 5 is shown having a multi-point contact 45 formed thereon. Multi-point contact 45 and curved element 33 together form gimbal mount 25. Multi-point contact 45 has three or more posts 50 that make point contact with curved element 33. In this embodiment of the invention, multi-point contact 45 is horizontally disposed for horizontal use of apparatus 5. In another embodiment of the invention (not shown), multi-point contact 45 may be vertically disposed for vertical use of apparatus 5.

In an alternative embodiment (not shown) of the invention, apparatus 5 has a pyramidal opening and a curved element, which together form gimbal mount 25. The pyramidal opening has four sides that make point contact with the curved element.

During use, once the angle of incidence is established, curved element 33 is fixed into position relative to multi-point contact 45. This fixation includes, but is not limited to, laser welding, soldering, epoxying, and resistance welding at the locations where posts 50 contact curved element 33.

In another preferred embodiment (not shown) of the present invention, a single small bore (not shown) with a diameter smaller that the diameter of curved element 33, may be used to seat curved element 33 with a rim contact.

In another preferred embodiment (not shown) of the present invention, a single large bore (not shown), with a diameter effectively the same as curved element 33, may be used to seat curved element 33 with an equatorial contact and a bottom point contact.

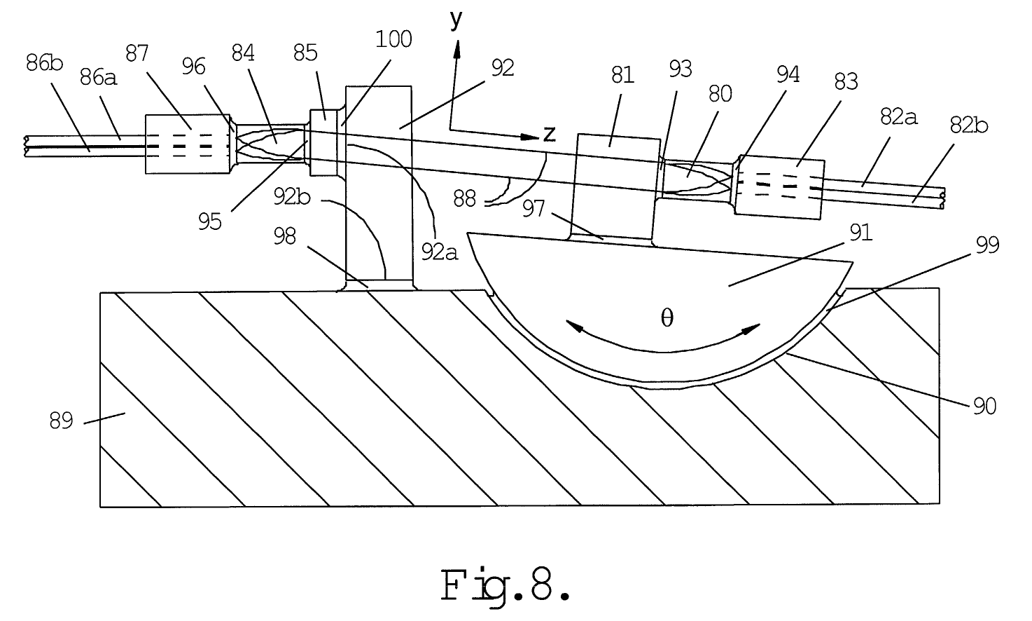

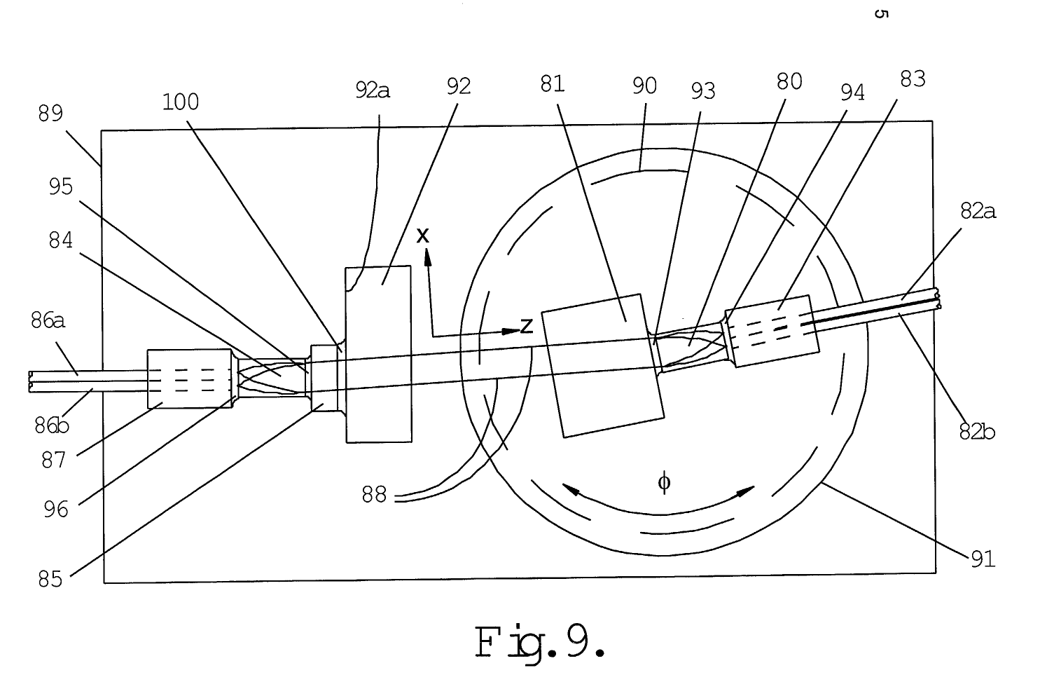

With particular reference to FIGS. 8 and 9, attention is now turned to an embodiment of the present invention in which neither of the two components being secured in fixed spatial relationship is itself a light source. This embodiment is an add/drop wavelength multiplexer/demultiplexer. The first of the two components is constituted by a first assembly consisting of a substantially quarter-period graded index lens (collimating lens) 80, on one end of which is located a spectrally selective dielectric filter 81 in the form of a spectrally selective narrow-transmission-band dielectric reflector, and on the other end of which is located the ends of two optical fibers 82a, 82b terminating in side-by-side relationship in a short capillary tube 83. The second of the two components is constituted by a second assembly consisting of a substantially quarter-period graded index lens 84, on one end of which is located a low-absorption low-reflectivity partial reflector 85, and on the other end of which is located the ends of two optical fibers 86a, 86b terminating in side-by-side relationship in a short capillary tube 87. The partial reflector 85 may be constituted by a coating deposited directly upon the end face of the graded index lens 84.

In use as a wavelength multiplexer, optical fibers 82a and 82b respectively constitute common highway input and output ports of the device, while optical fibers 86a and 86b respectively constitute the channel ‘add’ (input) port of the device and a monitoring (output) port for the ‘add’ channel. The filter 81 is a spectrally selective narrow-transmission-band dielectric reflector that is substantially totally reflective to light in all but one of the wavebands λ₁, λ₂, . . . λₙthe exception being waveband λₘ, where m is an integer lying in the range from 1 to n. (The wavebands λ₁, λ₂, . . . λₙ respectively compass the wavebands of channels 1 to n.) For waveband λₘ, the filter 81 is substantially totally transmissive. (In use as a wavelength demultiplexer, optical fibers 82a and 82b respectively constitute common highway output and input ports, while fiber 86aconstitutes the ‘drop’ (output) port.)

The capillary tube 83 is fixed in position on the end of graded index lens 80 so that the inboard end of fiber 82a is imaged by the lens, after reflection in filter 81, on the inboard end of fiber 82b. Similarly, the capillary tube 87 is fixed in position on the end of graded index lens 84 so that the inboard end of fiber 86ais imaged by the lens, after reflection in partial reflector 85, on the inboard end of fiber 86b. Since partial reflector 85 has low reflectivity, typically about 2%, the majority of light within waveband λₘ entering graded index lens 84 from fiber 86a will be transmitted through partial reflector 85 to emerge as a collimated beam 88. This light beam 88 is incident upon filter 81, is transmitted through it to be incident upon graded index lens 80 so as to be brought to a focus at the far end of that lens.

The task particularly addressed by the present invention in the context of this embodiment concerns a method of ensuring that the beam 88 is incident upon graded index lens 80 in such a position, and at such an angle, for that focus to be optimally registered with the inboard end of fiber 82b. (Reciprocity then ensures that, when the device is employed as a channel-dropping demultiplexer, light within waveband λₘ launched into fiber 82b, and hence transmitted through filter 81 will be imaged by graded index lens 84 on the inboard end of fiber 86a.) The alignment task is accomplished by securing the two graded index lens assemblies to a substrate 89, a substrate typically made of a low coefficient of thermal expansion material such as the low-expansion nickel cobalt steel alloy marketed under the trade mark ‘KOVAR’, in a way that makes provision for angular adjustments to the position of the first assembly (the assembly including graded index lens 80) relative to the substrate, and that makes provision for translational adjustments to the position of the second assembly (the assembly including graded index lens 84) relative to the substrate.

Most particularly, the angular adjustment is effected in a manner which obviates the need to have recourse to the use of wedge-shaped fillets of adhesive to secure the first assembly in its final adjusted position, such fillets being avoided because of their propensity to give rise to problems of thermal instability in the relative positioning of the two assemblies and to problems of asymmetric stress liable to introduce undesirable polarization dependent loss properties.

To this end, the substrate 89 is provided with a spherical well 90 in which is fitted a frustum 91 of a sphere (a portion of a sphere obtained by dividing that sphere into two portions by a planar section) having a complementary radius of curvature. The first assembly is mounted by a planar facet of its filter 81 on the planar facet of the frustum 91. The radii of curvature of the well 90 and the frustum 91 are typically of the order of 1 mm. The frustum 91 is typically made of silica, and its depth is preferably chosen to enable the first assembly to be secured with the axis of its graded index lens 80 passing through or close to the center of curvature of the frustum.

Correspondingly, the second assembly is mounted by the planar end facet of its partial reflector 85 against a planar facet 92a of a transparent mounting block 92, a cuboid, which is itself mounted by a further planar facet 92b against a planar portion of the substrate 89. Typically, this mounting block will be provided with an anti-reflection coating (not shown) to avoid unnecessary loss and to reduce spurious back-reflections.

Arbitrarily designating the direction of the collimated beam of light 88 as the (Cartesian) z direction, the mounting block 92 is oriented so that movement of partial reflector 85 over facet 92a affords a facility for making translational adjustments substantially in the (Cartesian) x and y directions (prior to final fixing); while movement of the mounting block towards, or away from, the well 90 affords a facility for making translational adjustments substantially in the z direction. (In actual practice the z direction will generally be aligned close to, although not precisely aligned with, the axial directions of the fibers 82a, 82b, 86a, and 86b, within their respective capillaries 83 and 87 but, for convenience of illustration only, deviations have been shown much exaggerated in FIGS. 8 and 9.) The complementary curvatures of the spherical well 90 and frustum 91 similarly afford (prior to final fixing) a corresponding facility for making θ pitch), φ (yaw) and ψ (roll) adjustments, (ψ (roll) adjustment not shown in either FIG. 8 or FIG. 9.) respectively about the x, y and z axes.

The first assembly is constructed by first securing the filter 81 to the end face of the graded index lens 80 with a layer 93 of substantially index-matched adhesive, for instance a uv-curing resin, and then using a similar layer 94, typically of the same resin, to secure the capillary tube 83 to the opposite end of the graded index lens 80. The use of a uv-curing resin to secure the capillary tube 83 and its fibers 82a and 82b to the graded index lens 80 allows their relative positions to be optimised with the uncured, and hence still fluid, resin in situ, and only once the optimised position of the capillary tube and lens has been found and maintained, is that resin cured with uv light in order to form a permanent rigid bond uniting the capillary tube and its fibers to the lens. A similar construction method is employed for construction of the second assembly using index-matched adhesive layers 95 and 96 for securing the graded index lens 84 respectively to the partial reflector 85 and to the capillary tube 87 and its fibers 86aand 86b.

The first assembly is then secured to the spherical frustum 91 by a layer 97 of adhesive, typically the same adhesive material as that of layers 93 to 96. Adjustment of the distance in the z direction separating the two assemblies can be made by movement of the mounting block 92 relative to the substrate 89 in the z direction. In practice, since light beam 88 is by intention a well-collimated beam, the optimal coupling between fibers 86a and 82b is relatively insensitive to small changes in the actual value of the distance in the z direction separating the two assemblies. Under these circumstances it is generally found acceptable to determine this distance by dead-reckoning, and 35 hence to secure the mounting block 92 to the substrate with an adhesive layer 98 before attempting the optimisation of the optical coupling between fibers 86a and 82b. Then, after the mounting block 92 has been secured to the substrate 89, the spherical frustum 91 is placed in the complementary spherical well 90 of the substrate 89 with an intervening quantity of uncured, and hence still fluid, adhesive which, upon subsequent curing, will form an adhesive layer 99. Similarly, the second assembly is located so that the end of its partial reflector 85 is placed against the mounting block 92, also with an intervening quantity of uncured adhesive which, upon subsequent curing, will form an adhesive layer 100. The adhesive of adhesive layers 98, 99 and 100 is typically the same adhesive as that of layers 93 to 97. While these two quantities of uncured adhesive remain fluid, exploration of the angular positioning of the first assembly by small rotational excursions of θ and φ (pitch and yaw excursions) of the spherical frustum relative to the substrate 89 are performed together with exploration of small linear excursions in the x and y directions of the second assembly relative to the mounting block 92 to find the optimum relative position of the two assemblies providing optimum optical coupling between fibers 86a and 82b. Then, while this optimum relative position is maintained, the two quantities of adhesive are cured to form adhesive layers 99 and 100, so securing the optimised relative positioning. When using a uv-curing resin, the uv light will be directed respectively through the frustum 91 and through the mounting block 92. Alternative processing involves optimisation of the alignment dry, then applying the adhesive to one of the joints, reoptimisation of the alignment and the curing of that adhesive; then applying adhesive to the other joint, reoptimisation of the alignment and the curing of this adhesive. This allows scope for effecting at least partial compensation of creep under circumstances in which significant creep is liable to occur upon curing of the quantities of adhesive

It may be noted that no mention was made concerning the making of rotational excursions of ψ (roll excursions) to secure optimum coupling between fibers 86a and 82b. This is because these fibers are designed to be circularly symmetric, and hence the coupling should be unaffected by such excursions of ψ. Nevertheless, it will be appreciated that the spherical frustum and complementary spherical well combination intrinsically affords the possibility of making excursions may be required when providing optimal optical coupling between certain combinations of optical component other than the graded index lens terminated optical fiber pairs of the add/drop of FIGS. 8 and 9. Such excursions might for instance be required if one of the optical components to be brought into optimal relative alignment were itself polarization-sensitive, for instance a waveplate or a polarizer, or if one or more of the optical fibers were non-circularly-symmetric, e.g. polarization-maintaining fiber.

It is also to be appreciated that if the nature of the two optical components to be brought into optimal relative alignment is such that the precise value of the distance in the z direction by which they are separated becomes of too critical importance to be reliably satisfied by dead-reckoning, the above-described construction method is readily modified to delay the curing of the adhesive layer 98 securing the second assembly's mounting block 92 to the substrate 89 until after the two optical components have been optimally aligned with respect to each other.

What is claimed is:

1. An optical device having a first optical element permanently secured in fixed spaced relationship with and substantially optimally optically coupled with, a second optical element, wherein the first optical element is permanently secured to a substrate, the second optical element is permanently secured to a mount, and wherein the mount is permanently secured to the substrate by a bond between mating faces of complementary spherical curvature.

2. An optical device as claimed in claim 1, wherein the complementary spherical curvature surfaces are provided by convex and concave surfaces respectively of the mount and of the substrate.

3. An optical device as claimed in claim 2, wherein the bond between the complementary spherical curvature surfaces is provided by an adhesive layer.

4. An optical device as claimed in claim 3, wherein the adhesive is a uv-curing resin.

5. An optical device as claimed in claim 2, wherein each of the first and second optical elements comprises a optical fiber pair terminated with a graded index lens.

6. An optical device as claimed in claim 5, wherein the graded index lens of one of said first and second elements is faced with a spectrally selective narrow-transmission-band dielectric reflector.

7. An optical device as claimed in claim 6, wherein the graded index lens of the other of said first and second elements is faced with a low-absorption low-reflectivity partial reflector.

8. An optical device as claimed in claim 4, wherein each of the first and second optical elements comprises a optical fiber pair terminated with a graded index lens.

9. An optical device as claimed in claim 8, wherein the graded index lens of one of said first and second elements is faced with a spectrally selective narrow-transmission-band dielectric reflector.

10. An optical device as claimed in claim 9, wherein the graded index lens of the other of said first and second elements is faced with a low-absorption low-reflectivity partial reflector.

11. A method of permanently securing a first optical element in fixed spaced relationship with, and substantially optimally optically coupled with, a second optical element, which method includes the step of permanently securing the first optical element to a substrate, the step of permanently securing the second optical element to a mount, and wherein the step of permanently securing the second optical element to the mount is followed by the step of permanently securing the mount to the substrate with adhesive located between mating surfaces of complementary spherical curvature respectively forming parts of the mount and of the substrate.

12. A method as claimed in claim 11, wherein each of the first and second optical elements comprises a optical fiber pair terminated with a graded index lens.

13. A method as claimed in claim 12, wherein the graded index lens of one of said first and second elements is faced with a spectrally selective narrow-transmission-band dielectric reflector.

14. A method as claimed in claim 13, wherein the graded index lens of the other of said first and second elements is faced with a low-absorption low-reflectivity partial reflector.
